(19) United States
(12) Patent Application Publication
(10) Pub. No.: US 2024/0239678 A1
(43) Pub. Date: Jul. 18, 2024

(54) ANTI-FOAMING MAGNESIUM HYDROXIDE SUSPENSION

(71) Applicant: TIMAB MAGNESIUM, DINARD (FR)

(72) Inventors: Sylvain BERTHELOT, LA MEZIERE (FR); François MAZARÉ, SAINT MALO (FR)

(21) Appl. No.: 18/560,267

(22) PCT Filed: May 10, 2022
(86) PCT No.: PCT/FR2022/050886

§ 371 Date: Nov. 10, 2023

(30) Foreign Application Priority Data
May 14, 2021 (FR) 2105073

(51) Int. Cl. C01F 5/14; C02F 1/66; C02F 103/18

(52) U.S. Cl. CPC C01F 5/14; C02F 1/66; C01P 2004/51; C01P 2004/61; C01P 2006/12; C01P 2006/22; C02F 2103/18

(57) ABSTRACT

The present invention relates to an aqueous magnesium hydroxide suspension comprising: a) at least 40 wt. %, relative to the total weight of the suspension, of magnesium hydroxide particles; b) from 0.001 to 5 wt. % relative to the total weight of the magnesium hydroxide of at least one dispersant and c) from 0.001 to 5 wt. %, relative to the total weight of the suspension, of at least one anti-foaming agent. The present invention further relates to the use of this aqueous suspension for the treatment of gas washing water in an on-board wet or semi-wet flue gas desulfurization system, the treatment of effluent at a municipal or industrial wastewater treatment plant, in industrial transformation processes or bioprocesses involving a fermentation or respiration process, or in the paper production process or in agriculture.

### TECHNICAL FIELD

The present invention relates to suspensions of magnesium hydroxide and uses thereof, in particular in industrial processes requiring the use of alkaline agents and encountering foaming problems, such as agriculture, the food industry, textiles, inks and coatings, lubricants, the paper industry, biotechnologies and the water and gas treatment industry, more particularly in the field of the treatment of municipal and industrial effluent or the treatment of process water or washing water within an industrial process. This relates in particular to the field of the treatment of gas washing water in a wet or semi-wet flue gas desulfurization system and the treatment of effluent at a municipal or industrial wastewater treatment plant, in particular at the steps involving aeration (clarification, nitrification/denitrification, etc.), biological microorganisms (phosphorus removal, biological, methanization, etc.) or the addition of chemical products such as polymers or disinfectants. Other applications of this suspension are, for example, industrial transformation processes or bioprocesses involving a fermentation (winemaking, beer production, etc.) or respiration process. Finally, this suspension can also potentially be used during the production of paper, at all steps of its manufacture, from the production of paper pulp to its bleaching step including the treatment of wastewater from the process or even for the recycling of the latter, in particular during the de-inking step.

### PRIOR ART

The prior art contains various examples of formulation and use of magnesium hydroxide suspensions. They are generally suspensions concentrated around 40 to 65 wt. % of small particles per unit weight of suspension. Although there are many ways to formulate a suspension, two main production methods stand out in the prior art: the suspension of solid particles of Mg(OH)₂ (or previously hydrated MgO) in water or the method in which Mg(OH)₂ is directly precipitated from a magnesium salt.

Magnesium hydroxide suspensions are used in many applications as an alkali or alkaline agent (basic substance) such as for example the neutralization of industrial acid discharges, the adjustment of the pH in the treatment of wastewater or gas washing process water or else during the bleaching of paper pulp. Using a suspension, as opposed to using a powder product, has several advantages. Among them, easier handling (dosing, transport) and the assurance of using a product with constant features compared to a product formulated on the end user's site.

The performance of a magnesium hydroxide suspension is judged in light of two major criteria, its reactivity and its stability. These two parameters are intrinsically related to the nature of the precursors and the method of preparation of the suspension directly influencing the physicochemical parameters of the latter, the most important parameters being, the concentration of solid matter as well as the size, shape and particle porosity.

The reactivity of a magnesium hydroxide suspension can be compared to the number of active sites per unit weight of the product and more broadly to the specific surface area (SSA) of the powder. Generally, this is about reactivity under the cover of a kinetic approach. Mg(OH)₂ having by nature a low solubility in water, high reactivity is required for the suspension in all the above applications.

The stability of a magnesium hydroxide suspension encompasses several sub-criteria, the latter being almost exclusively related to its implementation, its use and its handling including preparation, packaging, transport, flow, pumping, etc. The literature indicates that a suspension is pumpable when the level of viscosity of the latter is such that its agitation (maintenance of the suspension without sedimentation, re-homogenization, resuspension) and its movement (transport in pipeline, pumping) are facilitated. Empirically, it was determined that magnesium hydroxide suspensions called pumpable magnesium hydroxide suspensions have a dynamic viscosity of less than 1000 mPa·s (measured using a Brookfield viscometer at 20° C. at 1.7 s⁻¹) and preferably less than 700 mPa·s to be easily pumpable.

The rheological stability of a suspension is therefore generally reduced to its viscosity value. Generally speaking, the viscosity of a Mg(OH)₂ suspension increases with the increase in the dry matter concentration of the suspension, with the decrease in the size of the Mg(OH)₂ particles and the increase in the specific surface of the latter.

Generally, the viscosity of magnesium hydroxide suspensions does not increase when the solid concentration remains below 40 wt. %. In this case, the suspension behaves like a Newtonian fluid. However, viscosity levels are not sufficient to keep the magnesium hydroxide particles in suspension. The suspension then shifts very quickly and a bed of particles forms at the bottom of the container. This sediment is all the more coherent and difficult to disperse as the particles used are fine and reactive. Such a result is not possible because the suspension subsequently becomes unusable.

When the concentration of dry matter exceeds 40 wt. %, the viscosity increases suddenly and the result is a non-Newtonian shear-thinning and thixotropic fluid whose behavior is viscoelastic or even Binghamian. The behavior of these suspensions is related to the existence of a 3D structure therein. When it is put in place, it ensures sufficient viscosity so that the particles do not sediment too quickly. This structure is then destroyed by the application of a mechanical stress greater than the threshold stress of the material in order to cause flow. These transformations are reversible. However, when the mineral charge continues to increase, the interactions between the solid and liquid carrier also continue to increase until a stage where the 3D structures created are no longer destructurable and structurable at will. The product then formed becomes very viscous and unusable. These changes in rheological behavior are the cause of numerous technical disadvantages, including the impossibility of stirring and transporting the suspensions despite the application of strong shear stresses.

In order to reduce these effects when increasing the amount of dry matter, the addition of a dispersing agent is a well-known practice in the prior art. The addition of a dispersant results in a reduction in viscosity by reducing interactions between solid particles. Patent application US2017/0225961 discloses a list of particularly functional dispersing agents for magnesium hydroxide suspensions. These agents aim at reducing the viscosity and therefore the negative effects related to high viscosity values so that the suspension can thus recover interesting rheological properties. The latter are the main rheological additives used in suspension formulations.

In certain cases, it is also possible to add non-associative gelling agents or thickeners in order to increase the viscosity at a low speed gradient. The properties provided to the medium following this addition are, for example, an exacerbated shear-thinning and non-thixotropic behavior and a greater flow threshold. The advantage of these additives is that they do not have a high gradient effect. They are often used to improve storage stability. Among these agents, it is possible to find cellulose derivatives, xanthan gum, alginates, polyvinyl alcohols (PVA), polyethylene glycol (PEG) or polyoxyethylenes (POE), polyvinylpyrrolidones (PVP) or else certain members of the acrylic (co)polymer (ASE) family.

The addition of such agents in the formulation will give rise to new complex solvent/particles, particles/particles, particles/agent, agent/agent, agent/solvent interaction mechanisms. Thus, determining the optimal dose is generally careful empirical work. The suspension is then said to be in equilibrium and stable with respect to the rheological changes that may occur during its successive manipulations; it is in particular less sensitive to the aging phenomena observed with certain suspensions.

Indeed, the aging of magnesium hydroxide suspensions is generally related to variations in the specific surface area or the crystal system of the particles but also to the re-agglomeration of particles together leading to their sedimentation. The stability of a magnesium hydroxide suspension is generally evaluated over time. A suspension that is not very dependent on aging sees its viscosity change little over time.

Aging of suspensions can take place in stationary (rest phase), dynamic (agitation phase) or mixed conditions (rest-agitation alternation). Aging in stationary conditions is generally characterized by more or less rapid sedimentation depending on the size of the particles generating zones where the dry matter concentration is higher.

The aging phases of suspensions reflect common industrial practices (alternation of storage and transport cycles). During these phases, agitation prevents sedimentation that is harmful to product optimization. The more stable a suspension is (under the conditions defined previously), the less energy this suspension will require to compensate for its sedimentation. Moreover, the better stability of a suspension will reduce the risk of clogging in areas of low turbulence, particularly at the cavities of a pump or at bends encountered on the hydraulic path.

In conclusion, the formulation of a magnesium hydroxide suspension with high reactivity and stability requires perfect control of the formulation of said suspensions, in particular in terms of the selection of the raw material and the additives, their amount, the sequence of addition of the latter and all physical treatments applied during suspension (agitation, grinding, dilution, etc.). The result of such an operation is a suspension in equilibrium where any disturbance related to the post-production addition of a chemical compound can disrupt this equilibrium and reduce the reactivity and/or stability performance of the product.

Foaming problems are frequently encountered in the industry. The foam encountered therein can be of different nature (aqueous, organic or biological). In all cases, they are characterized by the dispersion of gas bubbles (O₂, CO₂, air, etc.) in a liquid. The balance between the arrival of new bubbles at the surface and their persistence determines whether an accumulation of bubbles is possible and therefore whether the formation of foam is possible. The persistence of this foam is conditioned by the stability of the gas/liquid interface separating the bubbles from each other. Thermodynamically, the foams are unstable. On the other hand, they can be metastable for a given time period. The factors having a direct impact on the stability of foams are as follows:
A-Drainage of bubble surfaces by gravity;
B-Diffusion of gas through the bubbles;
C-Balance of attractive and repulsive forces between the bubbles;
D-Transport of liquid by capillary within gas/liquid interfaces.

Certain chemical compounds have the ability to increase the duration of foam persistence. They are called foaming agents. These agents can be of different physicochemical nature. There are 3 main families of foaming agents.
Surfactants are molecules generally composed of a hydrophilic polar head and a hydrophobic polar tail (effect on A, B, C and D).
Macromolecules can be polymers or organic molecules, they generally act on A and C in their capacity as electrolyte or viscosity modifier.
Solid particles can reduce the surface tension of liquids and thus contribute to the stabilization of the foam. The combination of gas, liquid and solid particles gives rise to froth. The particles adhere to gas/liquid interfaces and thus contribute to their reinforcement against destructive forces that can lead to the coalescence of foam or froth (mechanical agitation, injection of pressurized air, etc.). They also reduce the drainage of the interface, further contributing to the stabilization of the foam.

Foaming problems can have harmful consequences on the proper operation of an industrial process or a treatment process. The most identified problem is the overflow of reactors containing the foaming liquid, causing safety problems (treatment of contaminated effluents) or loss of production (fermentation tanks). The subsequent cleanup associated with these overflows is often tedious.

In the context of treatment processes or industrial processes involving the use of an alkali (or alkaline agent) and more particularly within a process for treating gas washing water in an on-board wet or semi-wet flue gas desulfurization system, foaming problems can be solved in different ways.

Solutions that can easily be implemented include: reducing cascade operations, sealing leaks, reducing gas velocity, incorporating expansion tanks, etc.

Other, more restrictive solutions can be considered, in particular the modification of the size of the equipment required to transport or contain the (potentially) foaming liquid or the addition of auxiliary structures such as overflow or retention basins.

Mechanical methods can also be implemented such as the installation of a spraying device, a vacuum deaeration device, centrifugation, a wave generator or else an electrostatic dust removal device. It is also considered to modify the temperature of the liquid. Indeed, an increase in the latter lowers the surface tension of the liquid. Finally, the injection of dry air is also a potential solution provided that it is well controlled so as not to cause the generation of additional foam.

However, these methods can be difficult to be implemented and are not always sufficient to effectively and optimally address the foaming problems, particularly in the field of gas washing water treatment processes in an on-board wet or semi-wet flue gas desulfurization system.

Indeed, the majority of these systems were sized without taking into account the potential foaming problems that could arise within the unit but so that the gas treatment is optimized. Therefore, modifying the process parameters is not trivial.

Likewise, these units, installed on board merchant ships or cruise ships, are generally disposed in narrow and confined areas of the boat. The installation of auxiliary structures or physical devices in order to disrupt the stabilization of the foam imposes too great technical, logistical and economic constraints. The same applies to devices allowing to control the level of foam within the system and overcome foaming problems by continuous or periodic injection of a defoaming agent.

Another solution is to add an anti-foaming agent directly into the process. However, the inventors surprisingly realized that it was possible to use the alkaline agent represented by the magnesium hydroxide suspension as an anti-foaming agent by preparing a particular magnesium hydroxide suspension having such a function without the latter losing its reactivity and/or stability performance.

### Presentation of the Invention

The present invention therefore relates to an aqueous magnesium hydroxide suspension comprising:
a) at least 40 wt. %, advantageously at least 50 wt. %, more preferably at least 53 wt. %, relative to the total weight of the suspension, of magnesium hydroxide particles;
b) from 0.001 to 5 wt. %, advantageously from 0.01 to 4 wt. %, more advantageously from 0.1 to 3 wt. %, relative to the total weight of the magnesium hydroxide, of at least one dispersant, advantageously selected from the group consisting of homopolymers or copolymers of acrylic acid or methacrylic acid and their salts and a mixture thereof and lignosulfonates and mixtures thereof, in particular selected from polycarboxylates, polyether polycarboxylates, polyacrylates, polyacrylate copolymers, acrylic and/or methacrylic copolymers, salts (in particular polyacrylate salts) and a mixture thereof, and
c) from 0.001 to 5 wt. %, advantageously from 0.005 to 1 wt. %, more advantageously from 0.01 to 0.5 wt. %, relative to the total weight of the suspension, of at least one anti-foaming agent, advantageously selected from the group consisting of silicone oils (such as polydimethysiloxanes in particular marketed by the company Kurita or by the company ArrMaz) or organic oils, polyglycols, fatty acid esters or polyesters and mixtures thereof, said oils or polyglycols possibly containing organic or mineral particles in suspension.

The suspension according to the invention therefore comprises (a) particles of magnesium hydroxide in a content of at least 40 wt. %, advantageously at least 50 wt. %, more advantageously at least 53 wt. %, relative to the total weight of the suspension. The content of these particles (a) can even go up to 58 wt. % and even up to 65-70 wt. %.

In one embodiment, the magnesium hydroxide particles have a volume average size, specifically a volume average diameter, D₉₀ less than 200 μm, preferably less than 100 μm, in particular less than 45 μm, more preferably less than 25 μm, even more preferably less than 15 μm, measured by a laser particle size analyzer, specifically the Mastersizer 2000 from Malvern Instruments, more specifically obtained after dilution of the suspension to 20000^{th} and passage through the particle size analyzer.

In another embodiment, the magnesium hydroxide particles have a volume average size, specifically a volume average diameter, D₅₀ less than 40 μm, preferably less than 20 μm, in particular less than 7 μm, even more preferably less than 2.5 μm, measured by a laser particle size analyzer, specifically the Mastersizer 2000 from Malvern Instruments, more specifically obtained after dilution of the suspension to 20000^{th} and passage through the particle size analyzer.

In another embodiment, the specific surface area of the magnesium hydroxide particles is comprised between 5 and 100 m²/g measured by multipoint BET method by N₂ adsorption, in particular with Micromeritics Gemini VII equipment.

The suspension according to the invention therefore further comprises (b) at least one dispersant, in a content of 0.001 to 5 wt. %, advantageously from 0.01 to 5 wt. %, in particular from 0.01 to 4 wt. %, more advantageously from 0.1 to 5 wt. %, in particular from 0.1 to 3 wt. %, relative to the total weight of the magnesium hydroxide.

In a particular embodiment, the at least one dispersant is selected from the group consisting of homopolymers or copolymers of acrylic acid or methacrylic acid and their salts and a mixtures thereof and lignosulfonates and mixtures thereof, in particular selected from polycarboxylates, polyether polycarboxylates, polyacrylates, polyacrylate copolymers, acrylic and/or methacrylic copolymers, salts (in particular polyacrylate salts), such as sodium salts (in particular sodium polyacrylates) and a mixture thereof. Specifically, the at least one dispersant is a polyether polycarboxylate or a polyacrylate, in particular a polyether polycarboxylate or polyacrylate salt, in particular a polyacrylate salt, more particularly a sodium polyacrylate.

The dispersant can be in the form of an aqueous solution, in particular having a solid content of 40 wt. % relative to the total weight of the aqueous dispersant solution. Advantageously, the dispersant is not or does not comprise alkyl benzene sulfonate, more advantageously it is not isopropylamine dodecyl benzene sulfonate.

The suspension according to the invention moreover comprises (c) at least one anti-foaming agent, in a content of 0.001 to 5 wt. %, advantageously from 0.005 to 1 wt. %, more advantageously 0.01 to 0.5 wt. %, even more advantageously in a content comprised between 0.01 and 0.05 wt. %, in particular in a content comprised between 0.01% and 0.04% relative to the total weight of the suspension.

In an advantageous embodiment, the at least one anti-foaming agent does not comprise silicone oil (such as polydimethysiloxanes in particular marketed by the company Kurita or by the company ArrMaz) or silicone product or polydimethysiloxanes or product based on silicone or based on silicone oil, more particularly with or without silica particles, more advantageously the anti-foaming agent is not a silicone oil, with or without silica particles, even more particularly the anti-foaming agent is not a polydimethysiloxane with or without silica particles.

In a particular embodiment, the at least one anti-foaming agent is selected from the group consisting of organic oils (such as hydrocarbon oils), polyglycols, fatty acid esters or polyesters (such as polyester polyols esterified with natural fatty acids in particular marketed by the company ArrMaz, esters of natural fatty acids, in particular marketed by the company ArrMaz, and polyether polyols esterified with natural fatty acids, in particular marketed under the name Flofoam™ H by the company SNF) and mixtures thereof, said oils or polyglycols possibly containing organic particles (such as wax particles) or mineral particles (such as silica dioxide particles) in suspension.

In another particular embodiment, the at least one anti-foaming agent is selected from the group consisting of organic oils (such as hydrocarbon oils), fatty acid esters or polyesters (such as polyester polyols esterified with natural fatty acids in particular marketed by the company ArrMaz, esters of natural fatty acids, in particular marketed by the company ArrMaz, and polyether polyols esterified with natural fatty acids, in particular marketed under the name Flofoam™ H by the company SNF) and mixtures thereof, said oils possibly containing organic particles (such as wax particles) in suspension.

In yet another particular embodiment, the at least one anti-foaming agent is selected from the group consisting of organic oils (such as hydrocarbon oils), polyether polyols esterified with natural fatty acids (for example having a viscosity at 20° C. of 200 mPa·s, and/or a density at 20° C. of 0.92 g/cm³, in particular marketed under the name Flofoam™ H by the company SNF, and mixtures thereof, said oils possibly containing organic particles (such as wax particles) in suspension.

In yet another particular embodiment, the at least one anti-foaming agent is a dispersion of organic particles, in particular of wax, in an organic oil, in particular a hydrocarbon oil, advantageously a dispersion of wax particles in a hydrocarbon oil. More particularly, the at least one anti-foaming agent has a viscosity at 20° C. of 350 mPa·s, and/or a density at ° C. of 0.855 g/cm³, and may be available commercially under the name Flofoam™ D from the company SNF.

The aqueous magnesium hydroxide suspension according to the invention therefore advantageously comprises water (d) as the only solvent.

The suspension according to the invention may optionally further contain a non-associative thickener or gelling agent, in particular as described above (for example cellulose derivatives, xanthan gum, alginates, polyvinyl alcohols (PVA), polyethylene glycol (PEG) or polyoxyethylenes (POE), polyvinylpyrrolidones (PVP) or else certain members of the acrylic (co)polymer (ASE) family), alkaline salts (for example magnesium acetate, potassium nitrate), and acidic conditioners (for example acetic acid, citric acid) or a mixture thereof.

In an advantageous embodiment, the aqueous magnesium hydroxide suspension according to the invention is essentially constituted by, in particular constituted by, the particles of magnesium hydroxide (a), the dispersant (b), the anti-foaming agent (c) and water (d) in the contents indicated above.

In one embodiment, the viscosity of the aqueous magnesium hydroxide suspension according to the invention, measured at 1.7 s⁻¹ at 20° C. with a Brookfield viscometer, is less than 1000 mPa·s, preferably less than 700 mPa·s, in particular less than 300 mPa·s.

In an advantageous embodiment, the aqueous magnesium hydroxide suspension according to the invention is stable in the rest phase at room temperature. Advantageously the result of its “7^{th} day 2^{nd} pour test” is at least 90%.

The prior art such as patent application US2017/0225961 indicates that the stability of a Magnesium hydroxide suspension can be evaluated using the pour test method. This is a method that allows to evaluate the amount by weight of product that can be extracted from a given container after 7 days or 14 days.

In this test, 50 g of magnesium hydroxide suspension sample is poured into a 60 mL PP (polypropylene) or HDPE (high-density polyethylene) bottle. The total weight of the assembly is then measured as well as the height of the meniscus of the suspension relative to the base of the container. The sample is then left to stand for 7 or 14 days.

After 7 days or 14 days, the sediment level is marked and the sediment height is measured relative to the base. Then the container is opened and the product is allowed to flow for 30 seconds. Then the sample is closed and the residual weight is evaluated. The resulting weight corresponds to the weight of “7^{th} day or 14^{th} day-1^{st} pour test”. It is then compared to the initial weight of the sample and the extraction percentage is then calculated. Then the container is agitated again and the product is allowed to flow again for 30 seconds. The sample is closed and the residual weight is evaluated. The resulting weight corresponds to the weight of “7^{th} day or 14^{th} day 2^{nd} pour test” and is then compared to the initial weight of the sample. The result is then expressed by the ratio (in %) between the weight of “7^{th} day or 14^{th} day 2^{nd} pour test” and the initial weight of the sample.

The present invention further relates to the use of the aqueous magnesium hydroxide suspension according to the invention for the treatment of gas washing water in an on-board wet or semi-wet flue gas desulfurization system, the treatment of effluent at a municipal or industrial wastewater treatment plant, in particular at the steps involving aeration (clarification, nitrification/denitrification, etc.), biological microorganisms (phosphorus removal, biological, methanization, etc.) or addition of chemicals such as polymers or disinfectants, in industrial transformation processes or bioprocesses involving a fermentation (winemaking, beer production, etc.) or respiration process or in the paper production process, in particular at all the steps of its manufacturing, from the production of paper pulp to its bleaching step, including the treatment of wastewater from the process or even for the recycling of the latter, in particular during the de-inking step, or else in agriculture. In particular, this use is as an alkaline anti-foaming agent. Thus advantageously the aqueous magnesium hydroxide suspension according to the invention is used in the field of agriculture, the food industry, textiles, inks and coatings, lubricants, the paper industry, biotechnologies and the water and gas treatment industry, more particularly in the field of the treatment of municipal and industrial effluent or the treatment of process water or washing water within an industrial process.

The present invention will be better understood upon reading the description of the figures and the examples which follow which are given for informational, non-limiting purposes.

### BRIEF DESCRIPTION OF THE DRAWINGS

FIG. 1 represents the pH curve as a function of time of acidified water in which a standard magnesium hydroxide suspension (MH1, MH2 and MH3) or a magnesium hydroxide suspension according to the invention (MH1AM4, MH2AM4 and MH3AM4) is added to neutralize the effluent under the conditions of example 2.1.

FIG. 2 represents a block diagram of an on-board desulfurization system.

### EXAMPLES

### Example 1: Testing Different Anti-Foaming Agents

The tests were carried out in order to come as close as possible to the foaming conditions encountered in an on-board wet or semi-wet flue gas desulfurization system.

The material used is:
acidified sea water (pH=2) (EDMA);
a magnesium hydroxide suspension (MH1) containing:
53 wt. % relative to the total weight of the suspension of magnesium hydroxide particles with granulometric distribution D₁₀=0.67 μm, D₅₀=2.18 μm and D₉₀=10.34 μm (measured by the laser particle size analyzer Mastersizer 2000 from Malvern Instruments after dilution of the suspension to 20000^{th} and passage through the particle size analyzer), and
0.25 wt. % relative to the weight of particles of a Polyether polycarboxylate dispersant in aqueous solution having a solid content of 40%;
a standard magnesium hydroxide suspension (MH2) containing:
58 wt. % relative to the total weight of the suspension of magnesium hydroxide particles with granulometric distribution D₁₀=2.36 μm, D₅₀=16.2 μm and D₉₀=66.4 μm (measured by the laser particle size analyzer Mastersizer 2000 from Malvern Instruments after dilution of the suspension to 20000^{th} and passage through the particle size analyzer), and
2.3 wt. % relative to the weight of particles of a sodium polyacrylate dispersant in aqueous solution having a solid content of 40%;
a magnesium hydroxide suspension (MH3) containing:
53 wt. % relative to the total weight of the suspension of magnesium hydroxide particles with granulometric distribution D₁₀=0.96 μm, D₅₀=4.86 μm and D₉₀=37.42 μm (measured by the laser particle size analyzer Mastersizer 2000 from Malvern Instruments after dilution of the suspension to 20000^{th} and passage through the particle size analyzer), and
5.0 wt. % relative to the weight of particles of a dispersant belonging to the category of lignosulfonates and mixtures thereof in aqueous solution having a solid content of 40%;
5 different anti-foaming agents;
Plastic stirring container % filled:
   Volume: 80 mL
   Cylinder with a height: h=8.3 cm.

The shape of the container and the amount of liquid added have been selected so as to accentuate foaming phenomena.

The different anti-foaming agents used are indicated in Table 1 below.

TABLE 1

| Anti- | | |
|---|---|---|
| foaming | | |
| agent | Supplier | Chemical family |
| AM1 | ArrMarz (USA) | Polyester(s) polyol(s) esterified with |
| | | natural fatty acids |
| AM4 | SNF (FR) (Flofoam D) | Hydrocarbon dispersion of organic |
| | | components |
| AM5 | ArrMarz (USA) | Polyester(s) polyol(s) esterified with |
| | | natural fatty acids |
| AM6 | SNF (FR) (Flofoam H) | Mixtures of polyether polyols esterified |
| | | with natural fatty acids |
| AM7 | Kurita (FR) | Polydimethylsiloxanes |

The test methodology is as follows:
1.20 mL of EDMA is added to the container.
2. An amount of 6 to 24 mg/L of magnesium hydroxide suspension is then added to neutralize the water to pH 6.
3. An amount of 5 ppm of the amount of liquid present in medium of the anti-foaming agent is then added to the system.
4. The container is sealed then shaken manually for 30 seconds.
5. The height of the foam formed is measured as a % of the total height of the cylinder.
6. A second dose of 15 ppm relative to the amount of liquid present in the medium of anti-foaming agent is then added and then steps 4 and 5 are repeated.
7. A third dose of 30 ppm relative to the amount of liquid present in the medium of anti-foaming agent is then added and then steps 4 and 5 are repeated.

The results are gathered in the following table 2.

TABLE 2

| | | total dosage in | | |
|---|---|---|---|---|
| | | ppm relative to | | |
| | Anti- | the amount of | height of | |
| Suspen- | foaming | liquid present | residual | |
| sion | agent | in the medium | foam in % | Comments |
| MH1 | AM1 | 5 | 8.3 | Low unstable froth - |
| | | | | Very rapid coalescence |
| MH1 | AM1 | 15 | 0 | No foaming |
| MH1 | AM4 | 5 | 0 | No foaming |
| MH1 | AM5 | 5 | 8.3 | Light non-homogeneous |
| | | | | froth - Rapid |
| | | | | coalescence |
| MH1 | AM5 | 15 | 0 | No foaming |
| MH1 | AM6 | 5 | 0 | No foaming |
| MH1 | AM7 | 5 | 8.3 | Light non-homogeneous |
| | | | | froth - Medium |
| | | | | coalescence |
| MH1 | AM7 | 15 | 8.3 | Light non-homogeneous |
| | | | | froth - Medium |
| | | | | coalescence |
| MH1 | AM7 | 30 | 0 | No foaming |
| MH2 | AM4 | 5 | 0 | No foaming |
| MH3 | AM4 | 5 | 0 | No foaming |

A lot more anti-foaming agent AM7 (30 ppm) must be used to obtain no foaming. It is therefore the least effective anti-foaming agent. Although all other anti-foaming agents had an effect, anti-foaming agents AM4 and AM6 demonstrated optimal effectiveness in this test. Indeed, they prevent the appearance of foaming for the minimum dose added to the effluent.

Therefore, the experiments with these agents were repeated using process water (pH=5, presence of sulfates and residues of incomplete combustion of heavy fuel oil) previously acidified to evaluate whether the effectiveness of these agents is maintained in a context closer to reality.

The results are summarized in Table 3 below.

TABLE 3

| | | total dosage in | | |
|---|---|---|---|---|
| | | ppm relative to | | |
| | Anti- | the amount of | height of | |
| Suspen- | foaming | liquid present | residual | |
| sion | agent | in the medium | foam in % | Comments |
| MH1 | AM4 | 5 | 0 | No foaming |
| MH1 | AM6 | 5 | 5 | Slight peripheral froth - |
| | | | | Fairly rapid coalescence |
| MH2 | AM4 | 5 | 0 | No foaming |
| MH3 | AM4 | 5 | 0 | No foaming |

Therefore, it appears that the anti-foaming agent AM4 is the agent which has the most anti-foaming power for the system in question. The other examples were carried out with this anti-foaming agent.

### Example 2: Testing Reactivity and Stability of the Suspension According to the Invention Containing the Anti-Foam AM4

These tests aim at evaluating the anti-foaming properties of the suspension according to the invention containing the anti-foam AM4 while quantifying the impact of the addition of this anti-foam on its reactivity and stability.

### Example 2.1: Reactivity of the Suspension

The material used is:
drinking water acidified at pH=3;
a standard magnesium hydroxide suspension (MH1) containing:
   53 wt. % relative to the total weight of the suspension of magnesium hydroxide particles with granulometric distribution D₁₀=0.67 μm, D₅₀=2.18 μm and D₉₀=10.34 μm (measured by the laser particle size analyzer Mastersizer 2000 from Malvern Instruments after dilution of the suspension to 20000^{th} and passage through the particle size analyzer), and
0.25 wt. % relative to the weight of particles of a Polyether polycarboxylate dispersant in aqueous solution having a solid content of 40%;
a magnesium hydroxide suspension according to the invention (MH1AM4) containing:
   53 wt. % relative to the total weight of the suspension of magnesium hydroxide particles with granulometric distribution D₁₀=0.67 μm, D₅₀=2.18 μm and D₉₀=10.34 μm (measured by the laser particle size analyzer Mastersizer 2000 from Malvern Instruments after dilution of the suspension to 20000^{th} and passage through the particle size analyzer), 0.25 wt. % relative to the weight of particles of a Polyether polycarboxylate dispersant in aqueous solution having a solid content of 40% and
   1000 ppm of anti-foaming agent AM4;
a standard magnesium hydroxide suspension (MH2) containing:
   58 wt. % relative to the total weight of the suspension of magnesium hydroxide particles with granulometric distribution D₁₀=2.36 μm, D₅₀=16.2 μm and D₉₀=66.4 μm (measured by the laser particle size analyzer Mastersizer 2000 from Malvern Instruments after dilution of the suspension to 20000^{th} and passage through the particle size analyzer), and
   2.3 wt. % relative to the weight of particles of a sodium polyacrylate dispersant in aqueous solution having a solid content of 40%;
a magnesium hydroxide suspension according to the invention (MH2AM4) containing:
   58 wt. % relative to the total weight of the suspension of magnesium hydroxide particles with granulometric distribution D₁₀=2.36 μm, D₅₀=16.2 μm and D₉₀=66.4 μm (measured by the laser particle size analyzer Mastersizer 2000 from Malvern Instruments after dilution of the suspension to 20000^{th} and passage through the particle size analyzer), and
   2.3 wt. % relative to the weight of particles of a sodium polyacrylate dispersant in aqueous solution having a solid content of 40% and 1000 ppm of anti-foaming agent AM4;
a standard magnesium hydroxide suspension (MH3) containing:
   53 wt. % relative to the total weight of the suspension of magnesium hydroxide particles with distribution D₁₀=0.96 μm, D₅₀=4.86 μm and D₉₀ =37.42 μm (measured by the laser particle size analyzer Mastersizer 2000 from Malvern Instruments after dilution of the suspension to 20000^{th} and passage through the particle size analyzer), and
   5.0 wt. % relative to the weight of particles of a dispersant belonging to the category of lignosulfonates and mixtures thereof having a solid content of 40%;
a magnesium hydroxide suspension according to the invention (MH3AM4) containing:
   53 wt. % relative to the total weight of the suspension of magnesium hydroxide particles with granulometric distribution D₁₀=0.96 μm, D₅₀=4.86 μm and D₉₀=37.42 μm (measured by the laser particle size analyzer Mastersizer 2000 from Malvern Instruments after dilution of the suspension to 20000^{th} and passage through the particle size analyzer), and
   5.0 wt. % relative to the weight of particles of a dispersant belonging to the category of lignosulfonates and mixtures thereof having a solid content of 40% and
   1000 ppm of anti-foaming agent AM4;
a pH meter.

The test methodology is as follows: A dose of 1700 mg/L of magnesium hydroxide suspension is added to neutralize the effluent. The evolution of the pH of the solution is followed as a function of time and plotted.

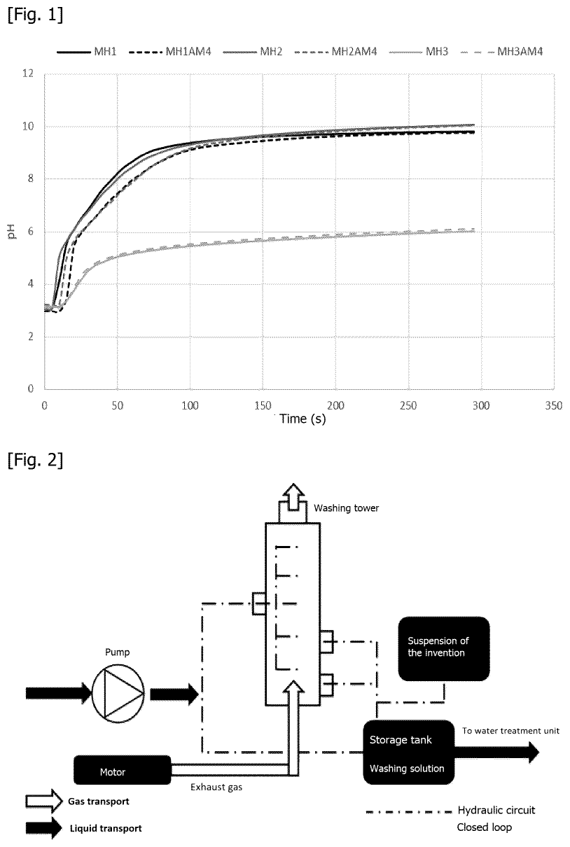

The results are shown in FIG. 1. Considering the results, the reactivity of a suspension according to the invention containing 1000 ppm of anti-foaming agent AM4 is little impacted by its presence. The kinetic behavior of the two suspensions becomes identical again after 3.5 minutes of reaction. The times allocated for alkalis to react within an industrial system are orders of magnitude greater.

### Example 2.2: Suspension Stability

The material used is:
a standard magnesium hydroxide suspension (MH1) as described in Example 2.1;
a magnesium hydroxide suspension according to the invention (MH1AM4) containing:
   53 wt. % relative to the total weight of the suspension of magnesium hydroxide particles with granulometric distribution D₁₀=0.67 μm, D₅₀=2.18 μm and D₉₀=10.34 μm (measured by the laser particle size analyzer Mastersizer 2000 from Malvern Instruments after dilution of the suspension to 20000^{th} and passage through the particle size analyzer), 0.25 wt. % relative to the weight of particles of a Polyether polycarboxylate dispersant in aqueous solution having a solid content of 40% and
   200 to 500 ppm of anti-foaming agent AM4;
a standard magnesium hydroxide suspension (MH2) as described in example 2.1;
a magnesium hydroxide suspension according to the invention (MH2AM4) containing:
   58 wt. % relative to the total weight of the suspension of magnesium hydroxide particles with granulometric distribution D₁₀=2.36 μm, D₅₀=16.2 μm and D₉₀=66.4 μm (measured by the laser particle size analyzer Mastersizer 2000 from Malvern Instruments after dilution of the suspension to 20000^{th} and passage through the particle size analyzer), and
   2.3 wt. % relative to the weight of particles of a sodium polyacrylate dispersant in aqueous solution having a solid content of 40% and
   200 to 500 ppm of anti-foaming agent AM4;
a standard magnesium hydroxide suspension (MH3) as described in example 2.1;
a magnesium hydroxide suspension according to the invention (MH3AM4) containing:
   53 wt. % relative to the total weight of the suspension of magnesium hydroxide particles with granulometric distribution D₁₀=0.96 μm, D₅₀=4.86 μm and D₉₀=37.42 μm (measured by the laser particle size analyzer Mastersizer 2000 from Malvern Instruments after dilution of the suspension to 20000^{th} and passage through the particle size analyzer), and
   5.0 wt. % relative to the weight of particles of a dispersant belonging to the category of lignosulfonates and mixtures thereof having a solid content of 40% and
   200 to 500 ppm anti-foaming agent;
Brookfield “RV series” viscometer.

The viscosity of the suspensions tested is measured at 1.7 s⁻¹ and at 20° C.

The results are presented in Table 4 below.

TABLE 4

| | | AM4 dose | Viscosity | |
|---|---|---|---|---|
| No | Suspension | (ppm) | (mPa · s) | Comments |
| 1 | MH1 | 0 | 180 | Original standard |
| | | | | suspension MH1 |
| 2 | MH1AM4 | 200 | 180 | No macroscopic changes |
| | | | | visible to the naked eye |
| 3 | MH1AM4 | 300 | 170 | No macroscopic changes |
| | | | | visible to the naked eye |
| 4 | MH1AM4 | 400 | 150 | No macroscopic changes |
| | | | | visible to the naked eye |
| 5 | MH1AM4 | 500 | 150 | No macroscopic changes |
| | | | | visible to the naked eye |
| 6 | MH2 | 0 | 130 | Original standard |
| | | | | suspension MH2 |
| 7 | MH2AM4 | 200 | 130 | No macroscopic changes |
| | | | | visible to the naked eye |
| 8 | MH2AM4 | 300 | 120 | No macroscopic changes |
| | | | | visible to the naked eye |
| 9 | MH2AM4 | 400 | 120 | No macroscopic changes |
| | | | | visible to the naked eye |
| 10 | MH2AM4 | 500 | 120 | No macroscopic changes |
| | | | | visible to the naked eye |
| 11 | MH3 | 0 | 100 | Original standard |
| | | | | suspension MH3 |
| 12 | MH3AM4 | 200 | 100 | No macroscopic changes |
| | | | | visible to the naked eye |
| 13 | MH3AM4 | 300 | 110 | No macroscopic changes |
| | | | | visible to the naked eye |
| 14 | MH3AM4 | 400 | 110 | No macroscopic changes |
| | | | | visible to the naked eye |
| 15 | MH3AM4 | 500 | 110 | No macroscopic changes |
| | | | | visible to the naked eye |

The viscosity of the suspension according to the invention remains within the preferential viscosity scale obtained after formulation.

### Example 2.3: Foaming Test with the Anti-Foaming Agent Integrated into the Suspension

The material used is:
IL beaker;
High shear rate mixer;
a standard magnesium hydroxide suspension (MH1) as described in example 2.1;
a magnesium hydroxide suspension according to the invention (MH1AM4) containing:
   53 wt. % relative to the total weight of the suspension of magnesium hydroxide particles with granulometric distribution D₁₀=0.67 μm, D₅₀=2.18 μm and D₉₀=10.34 μm (measured by the laser particle size analyzer Mastersizer 2000 from Malvern Instruments after dilution of the suspension to 20000^{th} and passage through the particle size analyzer), 0.25 wt. % relative to the weight of particles of a Polyether polycarboxylate dispersant in aqueous solution having a solid content of 40% and
   300 ppm of anti-foaming agent AM4;
a magnesium hydroxide suspension without dispersant (MH1′) containing:
   53 wt. % relative to the total weight of the suspension of magnesium hydroxide particles with granulometric distribution D₁₀=0.67 μm, D₅₀=2.18 μm and D₉₀=10.34 μm (measured by the laser particle size analyzer Mastersizer 2000 from Malvern Instruments after dilution of the suspension to 20000^{th} and passage through the particle size analyzer);
a dispersant solution (D1) containing Polyether polycarboxylate in aqueous solution concentrated at 2 wt. % relative to the weight of water;
a standard magnesium hydroxide suspension (MH2) as described in example 2.1;
a magnesium hydroxide suspension according to the invention (MH2AM4) containing:
   58 wt. % relative to the total weight of the suspension of magnesium hydroxide particles with granulometric distribution D₁₀=2.36 μm, D₅₀=16.2 μm and D₉₀=66.4 μm (measured by the laser particle size analyzer Mastersizer 2000 from Malvern Instruments after dilution of the suspension to 20000^{th} and passage through the particle size analyzer), and 2.3 wt. % relative to the weight of particles of a sodium polyacrylate dispersant in aqueous solution having a solid content of 40% and
   300 ppm of anti-foaming agent AM4;
a dispersant solution (D2) containing sodium polyacrylate in aqueous solution concentrated at 2 wt. % relative to the weight of water;
a standard magnesium hydroxide suspension (MH3) as described in example 2.1;
a magnesium hydroxide suspension according to the invention (MH3AM4) containing:
   53 wt. % relative to the total weight of the suspension of magnesium hydroxide particles with granulometric distribution D₁₀=0.96 μm, D₅₀=4.86 μm and D₉₀=37.42 μm (measured by the laser particle size analyzer Mastersizer 2000 from Malvern Instruments after dilution of the suspension to 20000^{th} and passage through the particle size analyzer), and 5.0 wt. % relative to the weight of particles of a dispersant belonging to the category of lignosulfonates in aqueous solution having a solid content of 40% and
   300 ppm of anti-foaming agent AM4;
a dispersant solution (D3) containing sodium lignosulfonate in aqueous solution concentrated at 4 wt. % relative to the weight of water.

The test methodology is as follows:
Dilution of the suspension evaluated by 10. The pH of this solution is such that: pH=10;
400 mL of suspension or solution are agitated vigorously for 10 minutes;
The incremental volume rate is measured and determined in volume %.
The evolution of the incremental volume after the end of agitation is evaluated qualitatively

The results are presented in Table 5 below.

TABLE 5

| | | Volume | |
|---|---|---|---|
| | | increment | |
| No | Test typology | (%) | Evolution of foam |
| 1 | Diluted MH1 standard | 8% | Stable foam |
| | suspension | | Slow coalescence |
| 3 | Standard MH1 suspension | 7.5% | Stable foam |
| | aged one year | | Slow coalescence |
| 4 | Dispersant solution D1 | 2% | Light foaming |
| | | | Fairly rapid coalescence |
| 5 | Diluted MH1′ suspension | 0% | No foaming |
| | without dispersant | | |
| 6 | Diluted MH1AM4 suspension | 2% | Unstable foam |
| | according to the invention | | Rapid coalescence |
| 7 | Diluted MH1AM4 suspension | 2% | Unstable foam |
| | according to the invention | | Rapid coalescence |
| | aged for 2 months | | |
| 8 | Diluted standard MH2 | 4% | Light foaming |
| | suspension | | Fairly rapid coalescence |
| 9 | Dispersant solution D2 | 2% | Light foaming |
| | | | Fairly rapid coalescence |
| 10 | Diluted MH2AM4 suspension | 0% | No foaming |
| | according to the invention | | |
| 11 | Diluted standard MH3 | 4% | Light foaming |
| | suspension | | Fairly rapid coalescence |
| 12 | Dispersant solution D3 | 2% | Light foaming |
| | | | Fairly rapid coalescence |
| 13 | Diluted MH3AM4 suspension | 0% | No foaming |
| | according to the invention | | |

The results show that the anti-foaming agent AM4 is effective in reducing the foaming phenomenon caused by the simultaneous presence of solid particles and dispersant molecules in a system which may correspond to an overdose situation in magnesium hydroxide suspension.

What is more, there is no aging effect over the first 2 months of the anti-foaming properties of the suspension according to the invention.

### Example 3: Full-Scale Test of the Suspension According to the Invention Containing the Anti-Foam AM4

The protocol is as follows: Ship A is a container carrier 400 m long and 60 m wide. Consuming heavy fuel oil (>2 wt. % of Sulfur), it complies with the regulations of the International Maritime Organization (IMO) by carrying out washing of its exhaust gases, wet desulphurization with Close Loop operating cycles.

Ship A therefore needs an alkaline agent in order to be able to neutralize the acidity provided by the absorption of SO₂ in its washing water. The alkaline chosen is a magnesium hydroxide suspension.

During operation, an overflow of the washing solution storage tank (labeled “holding tank”) was observed in the diagram in FIG. 2. The origin of the causes of this overflow was investigated and determined.

Indeed, the storage tank is equipped with vents allowing the depressurization of the tank following the arrival of air in the latter due to transport in pipes that are not completely submerged. The extraction capacity of these vents is such that they are capable of extracting foam, much less dense than the carrier liquid, to the outside of the tank. This foam overflows and settles on the deck of the ship. Once deposited, it coalesces and gives way to a polluted liquid having a risk for passengers and staff on board.

Before using a magnesium hydroxide suspension according to the invention as a means for remediation, several solutions were investigated without giving convincing results. These solutions correspond to modifications of the on-board desulfurization system:
Modification of the water level setpoint within the tank.
Reduction in the velocity of the washing solution arriving within the tank while ensuring the preserved effectiveness of the treatment.
Modification of the regulation algorithm at the pH thresholds in order to minimize overdose problems.

Although the implementation of these solutions yielded encouraging results, they were not sufficient to eliminate the foaming problem in all usage scenarios of the onboard desulfurization system. Overflow problems were always observed when the main scrubber treated the exhaust gases coming from the main motor when the latter was operating at more than 20% of its maximum speed.

Thus, the use of a magnesium hydroxide suspension with anti-foaming properties was considered, said suspension containing:
53 wt. % relative to the total weight of the suspension of magnesium hydroxide particles with granulometric distribution D₁₀=0.67 μm, D₅₀=2.18 μm and D₉₀=10.34 μm (measured by the laser particle size analyzer Mastersizer 2000 from Malvern Instruments after dilution of the suspension to 20000^{th} and passage through the particle size analyzer), 0.25 wt. % relative to the weight of particles of a Polyether polycarboxylate dispersant in aqueous solution having a solid content 40% and
300 ppm anti-foaming agent AM4.

### Test Results

The use of the magnesium hydroxide suspension according to the invention allowed to eliminate the foaming problem not only for previously problematic conditions of use (motor load>20%) but also in extreme scenarios of stress on the main motor (up to motor load>65%).

Additionally, the use of this suspension had no significant impact on:
The amount of magnesium hydroxide suspension consumed;
The pH levels reached in the tank;
The efficiency of the desulfurization process and
The smooth running of post-use water treatment operations.

It is therefore possible to conclude that the magnesium hydroxide suspension according to the invention effectively responds to the problem of foaming during the treatment of gas washing water in an on-board wet or semi-wet flue gas desulfurization system.

1-11. (canceled)

12. An aqueous magnesium hydroxide suspension comprising:
a) at least 40 wt. % relative to the total weight of the suspension, of magnesium hydroxide particles;
b) from 0.001 to 5 wt. % relative to the total weight of the magnesium hydroxide, of at least one dispersant, and
c) from 0.001 to 5 wt. % relative to the total weight of the suspension, of at least one anti-foaming agent.

13. The aqueous suspension according to claim 12, wherein the at least one dispersant is a polyether polycarboxylate or a polyacrylate.

14. The aqueous suspension according to claim 12, wherein the at least one anti-foaming agent is a dispersion of organic particles in an organic oil.

15. The aqueous suspension according to claim 12, wherein the magnesium hydroxide particles have a volume average size D₉₀ less than 200 μm measured by a laser particle size analyzer.

16. The aqueous suspension according to claim 12, wherein the magnesium hydroxide particles have a volume average size D₅₀ less than 40 μm measured by a laser particle size analyzer.

17. The aqueous suspension according to claim 12, the viscosity of which measured at 1.7 s⁻¹ at 20° C. with a Brookfield viscometer, is less than 1000 mPa·s.

18. The aqueous suspension according to claim 12, wherein it is stable in the rest phase at room temperature.

19. The aqueous suspension according to claim 12, wherein the specific surface area of the magnesium hydroxide particles is comprised between 5 and 100 m²/g.

20. The aqueous suspension according to claim 12, wherein the at least one anti-foaming agent does not comprise silicone oil.

21. A method of treatment of gas washing water in an on-board wet or semi-wet flue gas desulfurization system or of effluent at a municipal or industrial wastewater treatment plant comprising the addition of the aqueous suspension according to claim 12.

22. An alkaline anti-foaming agent comprising the aqueous suspension according to claim 12.
